(19) United States
(12) Patent Application Publication
(10) Pub. No.: US 2008/0238003 A1
(43) Pub. Date: Oct. 2, 2008

(54) Safety System for a Conveyance Mechanism

(76) Inventor: Thomas W. Burkard, Savage, MN (US)

Correspondence Address: KRAMM LAW, P.O. BOX 20726, BLOOMINGTON, MN, 55420-0726, US

(21) Appl. No.: 11/692,180

(22) Filed: Mar. 27, 2007

(51) Int. Cl. B62B 5/02; B23P 17/04

(52) U.S. Cl. 280/5.32; 29/428

(57) ABSTRACT

A vehicle for overcoming an obstacle that comprises a carriage and a translator. The translator comprises a translator member rotatably connected to the carriage and at least three wheels rotatably connected to the translator member. The three wheels have a coplanar, same orientation and substantially equilaterally triangular relation to each other for reducing resistance from the obstacle to the overcoming vehicle. A pulling force by the operator rotates the translator member and the third wheel joins the second wheel as both are biased against the same vertical second surface of the first stair. A still further pulling force by the operator rotates the translator member more so that the third wheel rolls over a corner of the first stair onto a horizontal third surface of the first stair while the second wheel still contacts the vertical second surface of the first stair.

### BACKGROUND OF THE INVENTION

Some embodiments of the invention relate to an improved safety system for a conveyance mechanism such as manually operated two wheel hand trucks or strollers.

Both manual and power driven vehicles with attachments for encountering obstacles have been know in the art for a long time. For example, manual two wheel hand trucks have been designed for conveying loads. An example of a two wheel hand truck is disclosed in Ferguson U.S. Pat. No. 5,464,234 which in FIGS. 3-6 illustrate a hand truck with a load encountering an obstacle of a curb. In use, the hand truck is first positioned with its rear side facing the curb, the arm in the outward latched position, and with the truck wheels on the lower surface adjacent the curb, and the truck cargo platform facing outward away from the curb. The truck rails are then manually pulled rearward and downward in an arch over the sidewalk to engage the distal end of the arm against the top of the curb. Continued pulling on the handles causes the wheels and cargo platform to raise above the top of the curb as the truck is pivoted on the arm. After the wheels are raised above the curb, and with continued downward rail movement and resultant angular change, the latch automatically disengages, the arm pivots toward a stored position of the distal end adjacent the cargo platform, resulting in movement of the truck horizontally as the wheels are lowered to the sidewalk.

Other manual vehicles such as strollers are also known in the art as exemplified by Saint U.S. Pat. No. 6,981,709 which in FIGS. 3 and 4 show a different apparatus for helping a stroller with a passenger negotiate the same curb obstacle. To improve maneuverability, the rear wheels are placed closer than usual to the front wheels, decreasing the wheelbase and providing greater leverage between the rear wheels and the rear handle. To compensate for the instability caused by the reduced wheelbase, a trailing support is provided behind the rear wheels. The trailing support may be a simple bar extension or have small wheels.

A drawback to the vehicles known in the art is that when elevators are unavailable and a vehicle with a heavy load must overcome an obstacle such as a curb or a stair with an even higher and sharper corner presents significant resistance to the vehicle. Multiple steps and flights of stairs compound the problem thereby presenting the possibility of loss and damage to the load or worse yet, physical injury to the operator or another in harms way. Thus, there is a need in the art for a safety system that reduces resistance to a vehicle with a heavy load that must overcome an obstacle such as a curb or stairs.

These and other objectives and advantages of the invention will appear more fully from the following description, made in conjunction with the accompanying drawings wherein like reference characters refer to the same or similar parts throughout the several views.

### SHORT STATEMENT OF THE INVENTION

Accordingly, the present invention of a safety system for a conveyance mechanism has been made keeping in mind the above problems so an object of the present invention is to provide a vehicle for overcoming an obstacle which allows for reducing resistance from the obstacle to the overcoming vehicle.

Another object of the present invention is to provide vehicles such as a hand truck some alternative form of running gear for reducing resistance from an obstacle.

In order to accomplish the above objects, the primary embodiment of the present invention provides a vehicle for overcoming an obstacle that comprises a carriage and a translator. The translator comprises a translator member rotatably connected to the carriage and at least three wheels rotatably connected to the translator member. The three wheels have a coplanar, same orientation and substantially equilaterally triangular relation to each other for reducing resistance from the obstacle to the overcoming vehicle.

### BRIEF DESCRIPTION OF THE DRAWINGS

This brief description of several views of the drawings and the detailed description of an embodiment the invention refers to different views for specifying the figure numbers and reference numerals to the different parts. The following described Figures are depicted within 1 sheet of drawings.

FIG. 1 is a perspective view of a preferred embodiment of the safety system for a conveyance mechanism of the present invention illustrating a hand truck with running gear in the form of a translator on stairs bearing a load;

FIG. 2 is a perspective view of the hand truck with one translator exploded off the central axle;

FIG. 3 is a side elevational view of the translator on ground level next to a first stair with a portion of the first translator member broken away to reveal obstructed details of the integral spacer and the second translator member;

FIG. 4 is an end elevational view taken along the line 4-4 of FIG. 3, of the translator on ground level exploded to illustrate various mounting details;

FIG. 5 depicts an exploded perspective view of a center portion of the translator 30 showing the integral spacer 34 between the first translator member 32 and the second translator member 33;

FIG. 6 is a progressional view of the translator 30 that starts from a position at the lower right of the FIG. 6 on ground level, is pulled to the left up some stairs, and rotates in a counterclockwise direction about the central axle 50.

### DETAILED DESCRIPTION OF THE INVENTION

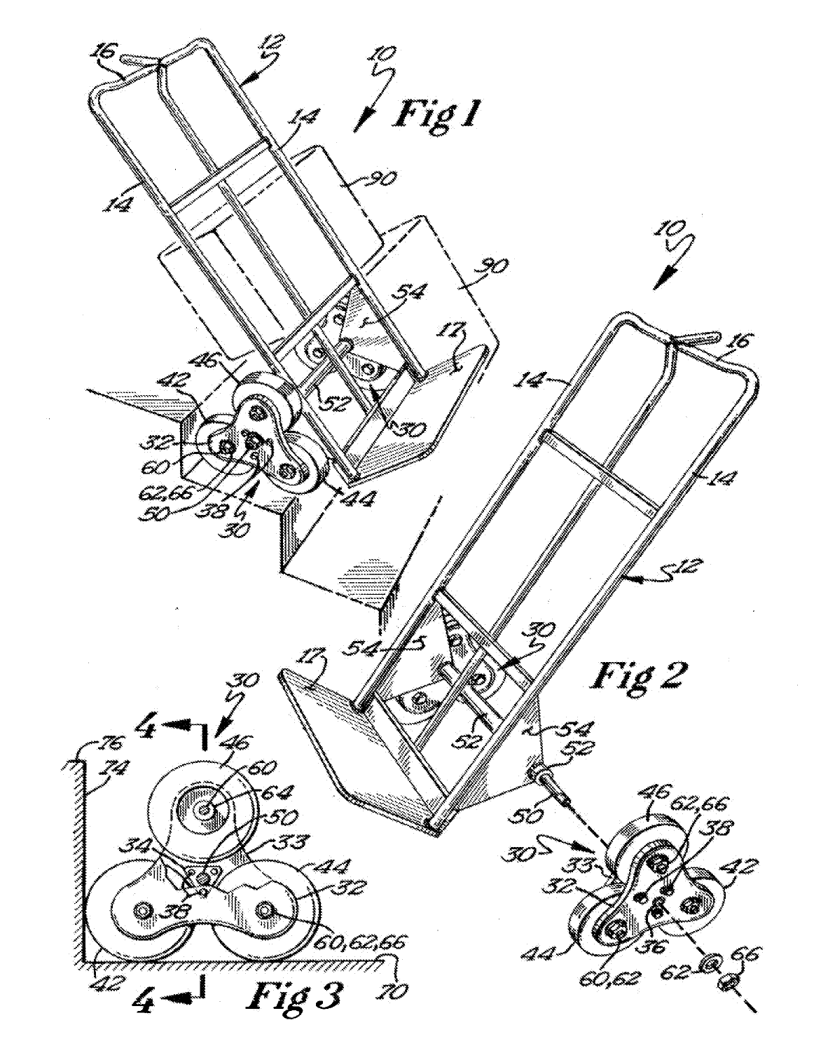

A preferred embodiment of the present invention is a safety system for a conveyance mechanism illustrated by way of example in FIGS. 1 through 6. With specific reference to FIGS. 1 through 2, a vehicle for overcoming an obstacle is shown in an embodiment of the invention as an upright hand truck 10 bearing a load 90 while overcoming stairs and comprises a carriage 12 and running gear in the form of a translator 30.

The term vehicle here refers to mechanisms adapted to travel on land and includes some form of running gear as an essential element. The running gear usually supports a load carrier, but may support a load directly, and adapts the vehicle to move over a surface. The basic purpose of these vehicles is the carrying of a load, either freight or passengers, from one place to another. The term “vehicle” also includes devices for towing a load and devices that are for special purposes identical with those in which a form of running gear is an essential element, and further includes such attachments for vehicles as are not limited in their position to any particular part of the vehicle. Some other embodiment of the invention examples of a vehicle include but are not limited to a hand truck, a barrow, a stroller, or an airplane.

The carriage 12 has a rectangular shape with a pair of elongated side rails 14 terminating at a hand grip area or handle 16 as depicted in FIG. 2 showing the hand truck 10 with one translator 30 exploded off the central axle 50. The central axle tube mounting 54 is fixed to the side rails 14 of the carriage 12.

The translator 30 comprises a translator member 32 rotatably connected to the carriage 12. The translator 30 also comprises at least three wheels 42, 44, 46 rotatably connected to the translator member 32. The three wheels 42, 44, 46 have a coplanar, same orientation and substantially equilaterally triangular relation to each other for reducing resistance from the obstacle to the overcoming vehicle. The three wheels 42, 44, 46 are positioned at a predetermined distance from each other such that the translator member 32 does not contact the obstacle to reduce resistance when overcoming a corner of the obstacle. The three wheels 42, 44, 46 have a height, wherein the height of the three wheels 42, 44, 46 is substantially similar to the predetermined height of the obstacle.

FIG. 3 provides a side elevational view of the translator 30 on the horizontal first surface 70 on a ground level next to a first stair 72 with a portion of the first translator member 32 broken away to reveal obstructed details of the integral spacer 34 and the second translator member 33.

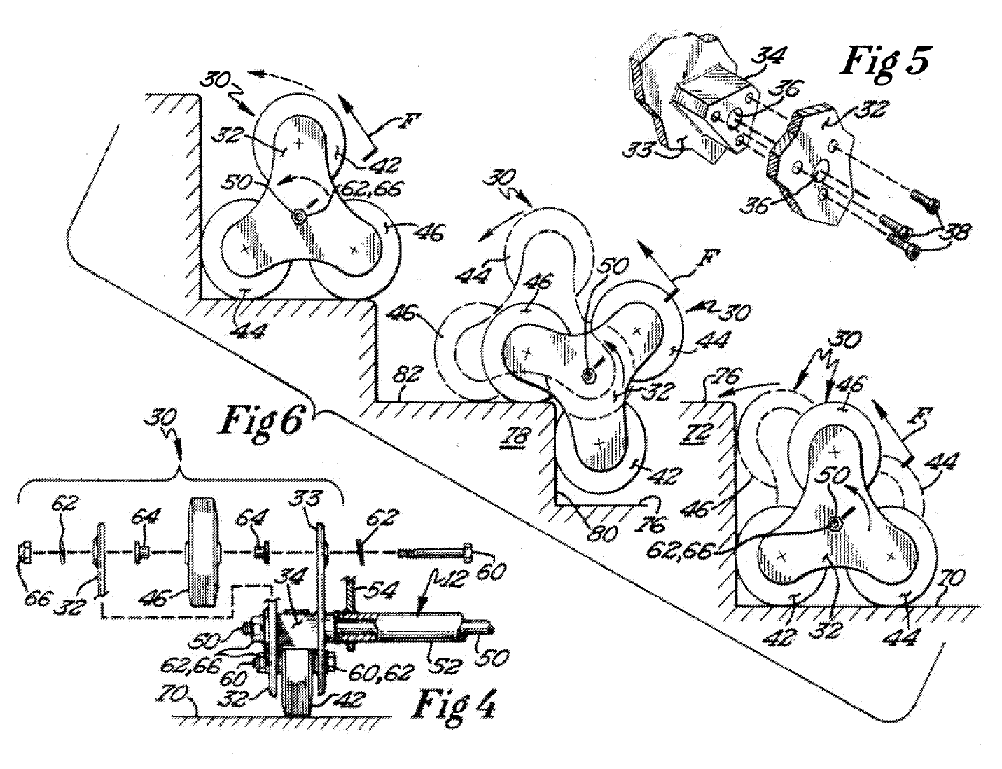

Refer now to FIG. 4 which presents an end elevational view of the translator 30 on the horizontal first surface 70 at ground level and exploded to illustrate various mounting details. The axle bolt 60 is disposed from right to left through the split lock washer 62, the second translator member 33, the bushing 64, the third wheel 46, another bushing 64, the first translator member 32, another split lock washer 62 and finally into the nut 66. The central axle 50 in this embodiment of the invention extends across the entire carriage 12 through the center of both translators 30. The central axle 50 is disposed within the entire length of the central axle tube 52, the first translator member 32, the integral spacer 34 and the second translator member 33. The central axle tube 52 in integrally attached to the central axle tube mounting 54.

FIG. 5 depicts an exploded perspective view of a center portion of the translator 30 showing the integral spacer 34 between the first translator member 32 and the second translator member 33. Defined by the integral spacer 34 are the central axle mounting aperture 36 and apertures for the mounting bolts 38.

A process for making a vehicle for overcoming an obstacle includes the steps of providing a carriage 12 and a translator 30 comprising a translator member 32 rotatably connected to the carriage 12 and at least three wheels 42, 44, 46 rotatably connected to the translator member 32. The three wheels 42, 44, 46 have a coplanar, same orientation and substantially equilaterally triangular relation to each other for reducing resistance from the obstacle to the overcoming vehicle. The three wheels 42, 44, 46 are positioned at a predetermined distance from each other such that the translator member 32 does not contact the obstacle to reduce resistance when overcoming a corner of the obstacle. The three wheels 42, 44, 46 also have a height, wherein the height of the three wheels 42, 44, 46 are substantially similar to the predetermined height of the obstacle. The vehicle may comprise a hand truck 10, a barrow, a stroller, or an airplane.

The process and device shown in FIG. 6 is a progression of a translator 30 that starts from a position at the lower right of the FIG. 6 on ground level, is pulled to the left up some stairs, and rotates in a counterclockwise direction about the central axle 50. At no point in the process does the obstacle stair corner contact the first translator member 32 or the second translator member 33. The translator 30 rotation is indicated by the quarter circular direction arrow in a counterclockwise direction about the central axle 50 in all three positions in FIG. 6. The F direction line indicates the direction of an upward force exerted by an operator of the hand truck 10 up the stairs from right to left which causes the translator 30 to rotate counterclockwise.

Also provided is a process for using a vehicle for overcoming an obstacle that includes the steps of providing a carriage 12 and providing a translator 30 comprising a translator member 32 rotatably connected to the carriage 12 and at least three wheels 42, 44, 46 rotatably connected to the translator member 32. The three wheels 42, 44, 46 have a coplanar, same orientation and substantially equilaterally triangular relation to each other for reducing resistance from the obstacle to the overcoming vehicle. The three wheels 42, 44, 46 are positioned at a predetermined distance from each other such that the translator member 32 does not contact the obstacle to reduce resistance when overcoming a corner of the obstacle. The three wheels 42, 44, 46 also have a height, wherein the height of the three wheels 42, 44, 46 are substantially similar to the predetermined height of the obstacle. The vehicle may comprise a variety of conveyance mechanisms such as for example a hand truck 10, a barrow, a stroller, or an airplane.

In operation, the hand truck 10 can be pulled up from a ground level over an obstacle with the new benefit of a translator 30 that improves the process by reducing resistance from the obstacle to the vehicle when overcoming the obstacle. In FIG. 6, the translator 30 of the hand truck 10 is positioned on a first surface 70 on a ground level. First and second wheels 42, 44 contact, while the third wheel 46 does not contact, the horizontal first surface 70 on the ground level. When the hand truck 10 is initially pulled at the handle 16 by an operator against a first stair 72, a vertical second surface 74 of the first stair 72 is only contacted by the first wheel 42. Upon further pulling force by the operator, the translator member 32 rotates and now the third wheel 46 joins the first wheel 42 as both are biased against the same vertical second surface 74 of the first stair 72. Preferably the height of the three wheels 42, 44, 46 are substantially similar to the predetermined height of the vertical second surface 74 of the first stair 72. A still further pulling force by the operator rotates the translator member 32 so that the third wheel 46 rolls over a corner of the first stair 72 onto a horizontal third surface 76 of the first stair 72 while the first wheel 42 still contacts the vertical second surface 74 of the first stair 72. The three wheels 42, 44, 46 are positioned at a predetermined distance from each other such that neither the first translator member 32 nor the second translator member 33 ever contact the corner of the first stair 72 thereby avoiding the creation of additional resistance overall. Finally, a further pulling force by the operator rotates the first translator member 32, the third wheel 46 rolls further along the horizontal third surface 76 of the first stair 72, the first wheel 42 rolls over the corner of the first stair 72 onto the horizontal third surface 76 of the first stair 72, and the second wheel 44 is now disposed above and between the first and third wheels 42,46 and not contacting any stair surface. Preferably both the first and third wheels 42,46 fit on the horizontal third surface 76 of the first stair 72.

Another obstacle in the form of a second step can be traversed by the vehicle in a similar manner. With the hand truck 10 positioned relative to the horizontal third surface 76 of the first stair 72, the first and third wheels 42,46 contact, but the second wheel 44 does not contact, the horizontal third surface 76 of the first stair 72. When the hand truck 10 is pulled at the handle 16 by an operator against a second stair 78, a vertical fourth surface 80 of the second stair 78 is contacted by the third wheel 46 only. Upon further pulling force by the operator, the translator member 32 rotates and the second wheel 44 is biased against the same vertical fourth surface 80 of the second stair 78 along with the third wheel 46. A still further pulling force by the operator rotates the translator member 32 so that the second wheel 44 rolls over a corner of the second stair 78 onto a horizontal fifth surface 82 of the second stair 78 while the third wheel 46 still contacts the vertical fourth surface 80 of the second stair 78. Finally, a further pulling force by the operator rotates the translator member 32, the second wheel 44 rolls further along the horizontal fifth surface 82 of the second stair 78, the third wheel 46 rolls over the corner of the second stair 78 onto the horizontal fifth surface 82 of the second stair 78, and the first wheel 42 is now disposed above and between the second and third wheels 44,46 and not contacting any stair surface.

While the safety system for a conveyance mechanism of the present invention has been disclosed in connection with a hand truck, it should be appreciated that the safety system can be used in other manual and power driven vehicles and conveyance mechanisms and is to be construed by way of illustration rather than limitation. This description is not intended to limit the invention or its applications or uses. Other various embodiments of the invention besides those already described will be appreciated. The principles of the invention taught are applicable to implementations operable in other environments, for example, strollers, barrows, and aircraft.

The present invention provides an improved conveyance mechanism which can be easily manipulated to overcome, for example, stairs, curbs, debris and other various obstacles. Thus, the conveyance mechanism of the present invention has the important advantage of providing a safety means to the operator.

What is claimed is:

1. A process for making a vehicle for overcoming an obstacle, comprising the steps of:
providing a carriage; and
providing a translator comprising:
a translator member rotatably connected to said carriage; and
at least three wheels rotatably connected to said translator member,
said three wheels having a coplanar, same orientation and substantially triangular relation to each other for reducing resistance from said obstacle to said overcoming vehicle.

2. The process for making a vehicle of claim 1, wherein said step of providing three wheels are positioned at a predetermined distance from each other such that the translator member does not contact the obstacle to reduce resistance when overcoming a corner of said obstacle.

3. The process for making a vehicle of claim 1, wherein said step of providing three wheels have a height, wherein the height of said three wheels are substantially similar to the predetermined height of the obstacle.

4. The process for making a vehicle of claim 1, wherein said step of providing three wheels have substantially equilaterally triangular relation to each other.

5. The process for making a vehicle of claim 1, wherein the vehicle is a hand truck;
wherein said step of providing three wheels are positioned at a predetermined distance from each other less than an average wheel radius of said three wheels to reduce resistance when overcoming a corner of said obstacle, wherein said three wheels have a height, wherein the height of said three wheels are substantially similar to the predetermined height of the obstacle, and wherein said three wheels have a substantially equilaterally triangular relation to each other.

6. The process for making a vehicle of claim 1, wherein the vehicle is selected from the group consisting essentially of a hand truck, a barrow, a stroller, or an airplane.

7. A vehicle for overcoming an obstacle, comprising:
a carriage; and a translator comprising:
a translator member rotatably connected to said carriage; and
at least three wheels rotatably connected to said translator member,
said three wheels having a coplanar, same orientation and a substantially triangular relation to each other for reducing resistance from said obstacle to said overcoming vehicle.

8. The vehicle of claim 7, wherein said three wheels are positioned at a predetermined distance from each other such that the translator member does not contact the obstacle to reduce resistance when overcoming a corner of said obstacle.

9. The vehicle of claim 7, wherein said three wheels have a height, wherein the height of said three wheels are substantially similar to the predetermined height of the obstacle.

10. The vehicle of claim 7, wherein said three wheels have substantially equilaterally triangular relation to each other.

11. The vehicle of claim 7, wherein the vehicle is a hand truck;
wherein said three wheels are positioned at a predetermined distance from each other less than an average wheel radius of said three wheels to reduce resistance when overcoming a corner of said obstacle, wherein said three wheels have a height, wherein the height of said three wheels are substantially similar to the predetermined height of the obstacle, and
wherein said three wheels have a substantially equilaterally triangular relation to each other.

12. The vehicle of claim 7, wherein the vehicle is selected from the group consisting essentially of a two wheel hand truck, a barrow, a stroller, or an airplane.

13. A process of using a vehicle for overcoming an obstacle, comprising the steps of:
providing a carriage; and
providing a translator comprising:
a translator member rotatably connected to said carriage; and
at least three wheels rotatably connected to said translator member,
said three wheels having a coplanar, same orientation and substantially triangular relation to each other for reducing resistance from said obstacle to said overcoming vehicle.

14. The process of using a vehicle claim 13, wherein said step of providing three wheels are positioned at a predetermined distance from each other such that the translator member does not contact the obstacle to reduce resistance when overcoming a corner of said obstacle.

15. The process of using a vehicle of claim 13, wherein said step of providing three wheels have a height, wherein the height of said three wheels are substantially similar to the predetermined height of the obstacle.

16. The process for using a vehicle of claim 13, wherein said step of providing three wheels have substantially equilaterally triangular relation to each other.

17. The process for using a vehicle of claim 13, wherein the vehicle is a hand truck;
wherein said step of providing three wheels are positioned at a predetermined distance from each other less than an average wheel radius of said three wheels to reduce resistance when overcoming a corner of said obstacle, wherein said three wheels have a height, wherein the height of said three wheels are substantially similar to the predetermined height of the obstacle, and wherein said three wheels have a substantially equilaterally triangular relation to each other.

18. The process of using a vehicle of claim 13, wherein the vehicle is selected from the group consisting essentially of a hand truck, a barrow, a stroller, or an airplane.
